(19) United States
(12) Patent Application Publication
(10) Pub. No.: US 2008/0109333 A1
(43) Pub. Date: May 8, 2008

(54) System and method for premium finance management

(75) Inventors: Willard Brent Camp, Montgomery, AL (US); Andrew Ward Waid, Montgomery, AL (US)

Correspondence Address: Baker & Daniels, Ste. 700, 805 15th Street, N.W., Washington, DC, 20005, US

(73) Assignee: Frazer Lanier Company, Montgomery, AL (US)

(21) Appl. No.: 11/543,102

(22) Filed: Oct. 5, 2006

(51) Int. Cl. G06Q 40/00

(52) U.S. Cl. 705/35

(57) ABSTRACT

Aspects of the present invention are directed to a method and system for premium financing for financing life insurance premiums for a life insurance policy issued by an insurer. The premium financing method may include obtaining taxable variable rate bonds from a bond issuing entity for funding the life insurance premiums. The method may additionally include creating an interest earning bond fund with the taxable variable rate bonds and paying the life insurance premiums to the insurer from the bond fund. Additional costs may be covered at least in part with bond fund interest.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to premium finance plans. More particularly, embodiments of the invention are directed to financing life insurance premiums.

### BACKGROUND OF THE INVENTION

Life insurance is generally an important component of a financial plan for individuals having high net worth. The purchase of adequate life insurance for individuals having high net worth often requires significant premium payments. Premium financing plans for the purchase of life insurance have existed for years to assist individuals in the purchase of life insurance Premium financing can be an effective strategy for clients who would like to avoid liquidating assets for funding life insurance premiums.

Premium financing may not be suited for every client. Generally, premium financing should be considered by clients with large estates who need to purchase substantial amounts of insurance due to estate tax liquidity issues but do not have the available cash to pay the premiums on such a policy. In addition, premium financing should only be used by those clients who understand the concept or financial leverage and are comfortable with the financing concept. Generally an individual or family prospect will have at least one of the following characteristics: (1) estate greater than five million dollars, (2) traditional funding of a policy inside an irrevocable trust will create gift taxes, (3) individual or family wealth is illiquid, but assets are available for collateral or a letter of credit can be obtained, or (4) the trust grantor and trustee understand financial leverage and are comfortable with the financing concept.

In a standard model for premium financing, an irrevocable trust borrows money from a third party lender unrelated to the life insurance carrier issuing the policy. Most programs use the life insurance policy itself as some type of collateral. Financing the premiums is a logical solution when the interest rate charged on the loan from the third party lender is lower than the rate the client would expect to earn on the assets that he or she did not need to liquidate in order to pay the premiums.

Premium financing for life insurance had until recently been limited to either a single national lender working exclusively with multiple pre-determined life insurance carriers or lending programs developed by the life insurance carrier itself. In addition, some banks were loaning premiums to preferred clients on a small scale. In recent years, a number of sources for premium financing have appeared including several national banks and brokerage firms that offer limited financing to their clients. Lenders frequently enter and leave the market and many lenders may have difficulties in reaching critical mass in these programs while others struggle to profitably price their loans in the market. Most recently, the market has seen the introduction of lender brokers that act like mortgage brokers in attempting to match borrowers to lenders. These brokers claim they can tailor a unique financing solution based on the individual client's situation. Generally, such brokers are paid by the lender through loan origination fees charged to the client.

Most premium financing lenders have general requirements based on minimum loan size and minimum net worth. Minimum loan size and minimum net worth requirements differ by lender and can be significant. Minimum loan size generally refers to the amount of funds borrowed to pay premiums. Accordingly, either the premium for the first year of the policy needs to meet a minimum amount or the total loan commitment needs to meet a minimum. For example, some lenders' minimum loan size is an initial 75,000 to 100,000 dollars in initial premium, while other lenders require a minimum loan commitment of one million dollars, usually based on a multiple year premium commitment. Some lenders will allow a borrower to aggregate the loans of multiple policies owned by the borrower to meet these minimum requirements. Minimum net worth requirements generally also exist. For example, a client's total net worth may be required to exceed five million dollars.

Loan interest is an important component of a premium financing arrangement. Generally, loan interest is made up of two components including an index such as LIBOR (London Interbank Offering Rate) and a spread that can range from 175 to 300 basis points. Similarly to a residential mortgage loan, the interest rate does not always equate to the best loan offer. Other factors need to be considered. For example, additional fees may include loan origination fees (0.5 to 1.25% of the total expected loan balance). These fees may be great enough to offset a low interest rate. Often, the fees must be paid up front.

Interest rates may be variable or fixed. Typical arrangements include a variable rate, with a portion of the interest determined by an index resetting each year. The spread on top of the index may be fixed for the life of the loan. The twelve month LIBOR and prime rate are common indices.

Due to the costs involved for the insured and the lenders, the currently available premium financing models are often unattractive to both premium finance clients and lenders. Thus, a more cost-effective solution is needed that will be more attractive to both premium finance clients and lenders.

### BRIEF SUMMARY OF THE INVENTION

In one aspect of the invention, a premium financing method is provided for financing life insurance premiums for a life insurance policy issued by an insurer. The premium financing method may include obtaining taxable variable rate bonds from a bond issuing entity for funding the life insurance premiums and creating an interest earning bond fund with the taxable variable rate bonds. The method may additionally include paying the life insurance premiums to the insurer from the bond fund and covering additional costs with bond fund interest.

In an additional aspect, a premium financing management system may be provided for managing financing of premiums for a life insurance policy issued by an insurer. The premium financing management system may include a trust loan amount calculation component for calculating a loan amount for issuance of taxable variable rate bonds from a bond issuing trust, the calculation based on life insurance premiums to be paid. The management system may additionally include a trust loan transfer component for transferring the taxable variable rate bonds to an interest earning bond fund and a premium payment transfer component for transferring premiums from the bond fund to the insurer.

In an additional aspect, a method may be provided for facilitating premium finance for a life insurance policy issued by an insurer and purchased by a policy holder.

The method may include causing formation of an agreement between the policy holder and a bond issuing entity, wherein the bond issuing entity issues variable taxable rate bonds for financing premiums of the purchased life insurance policy. The method may additionally include causing formation of an interest earning bond fund, wherein the issued variable taxable rate bonds are deposited in the interest earning bond fund. The method may additionally include routing premium payments from the interest earning bond fund to the issuer of the life insurance policy.

### BRIEF DESCRIPTION OF THE DRAWINGS

The present invention is described in detail below with reference to the attached drawings figures, wherein:

FIG. 1 is a block diagram illustrating components of a premium financing arrangement in accordance with an embodiment of the invention;

FIG. 2 is a block diagram illustrating components of a premium finance manager in accordance with an embodiment of the invention;

FIG. 3 is a block diagram illustrating components of a premium finance management system in accordance with an embodiment of the invention;

FIG. 4 is a diagram illustrating additional details of the premium financing arrangement in accordance with an embodiment of the invention;

FIG. 5 is a flow chart illustrating a premium financing method in accordance with an embodiment of the invention; and

FIG. 6 is a chart illustrating premium finance details in accordance with an embodiment of the invention.

### DETAILED DESCRIPTION OF PREFERRED EMBODIMENTS

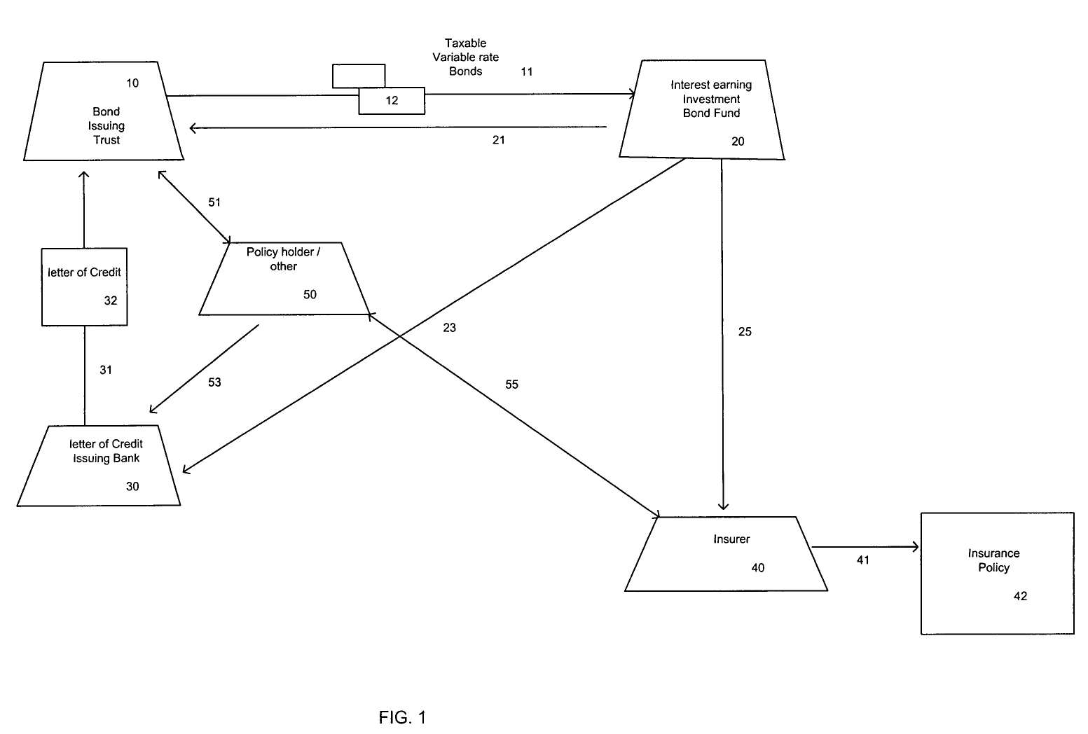

Embodiments of the present invention are directed to a system and method for premium financing. FIG. 1 is a block diagram illustrating a premium financing arrangement including participants and interaction between participants in accordance with embodiments of the invention. Participants may include a bond issuing trust or other bond issuing entity 10, an interest earning investment bond fund 20, a letter of credit issuing bank 30, an insurer 40, and a policy holder or purchaser 50 of an insurance policy 42.

The policy holder or purchaser 50 has contracted at 55 with an insurer 40 for issuance 41 of an insurance policy 42. In order to finance the insurance policy 42, the policy holder 50 has contracted at 51 with the bond issuing trust 10 to issue taxable variable rate bonds 12. The taxable variable rate bonds 12 may be deposited at 11 in the interest earning investment bond fund 20. Premiums due for the insurance policy 42 may be transferred at 25 from the interest earning investment bond fund 20 to the insurer 40. The bond issuing trust 10 may require a letter of credit 32 to be issued at 31 by the letter of credit issuing bank 30. The letter of credit issuing bank 30 may receive fees due at 53 from the policy holder and/or by transfer at 23 from the investment bond fund 20. Furthermore, interest due to the bond issuing trust 10 may be paid by the policy holder 50 at 51 and/or by the interest earning investment bond fund 20 at 21.

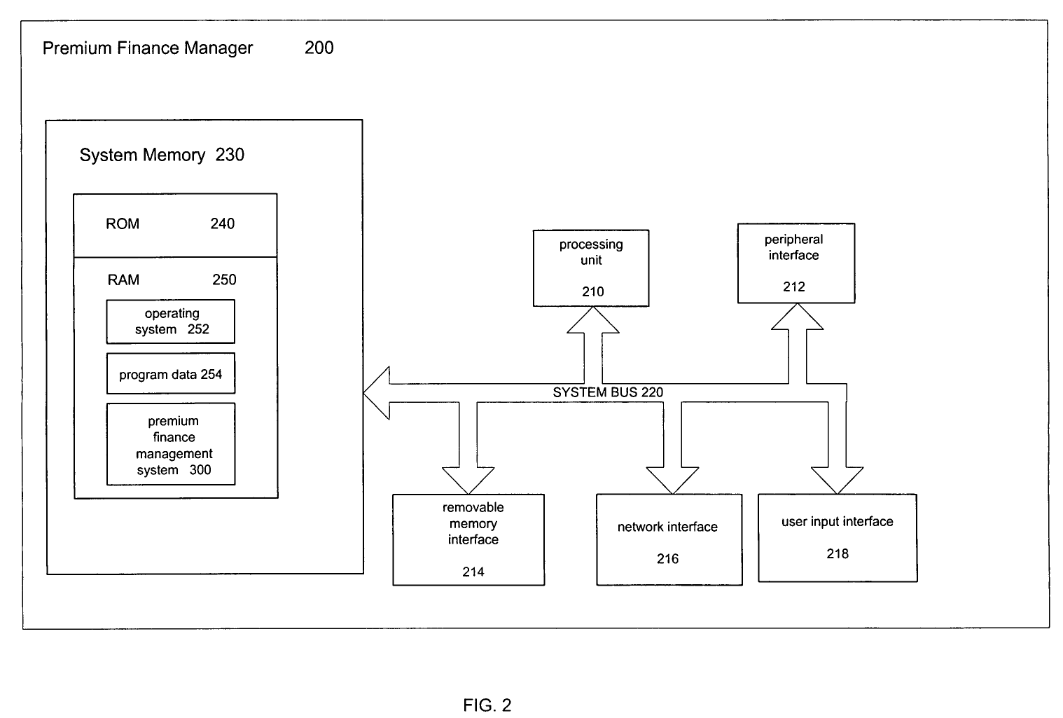

The transactions between the above entities may be centrally managed by a premium finance manager. FIG. 2 is a block diagram illustrating an embodiment of a premium finance manager 200. The premium finance manager 200 may incorporate one or more computing devices including a processing unit 210, a peripheral interface 212, a removable memory interface 214, a network interface 216, and a user input interface 218. The premium finance manager 200 may also include a memory 230. A system bus 220 may be used to couple the aforementioned components.

The system memory 230 may include computer storage media in the form of volatile and/or nonvolatile memory such as read only memory (ROM) 240 and random access memory (RAM) 250. A basic input/output system (BIOS), containing the basic routines that help to transfer information between elements within the security system server 200, such as during start-up, is typically stored in ROM 240. RAM 250 typically contains data and/or program modules that are immediately accessible to and/or presently being operated on by processing unit 210.

The RAM 250 may include an operating system 252, program data 254 and a premium finance management system 300. The premium finance management system 300 may include one or more applications for management the premium financing scenario illustrated in FIG. 1. The premium finance management system 300 and any other application programs stored in RAM 250 may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including multiprocessor systems, microprocessor-based or programmable consumer electronics, minicomputers, mainframe computers, and the like.

The premium finance manager 200 may also include other removable/non-removable, volatile/nonvolatile computer storage media. A hard disk drive may be provided that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive is typically connected to the system bus 220 through a non-removable memory interface. The magnetic disk drive and optical disk drive are typically connected to the system bus by a removable memory interface.

A user may enter commands and information through the user input interface 218 using input devices such as a keyboard and pointing device, commonly referred to as a mouse, trackball or touch pad. Other input devices may include a microphone, satellite dish, scanner, or the like. These and other input devices are often connected to the processing unit 210 through the user input interface 218 that is coupled to the system bus 220, but may be connected by other interface and bus structures, such as a parallel port or a universal serial bus (USB). A monitor or other type of display device and other peripherals may also be connected to the system bus 220 via an interface, such as the peripheral interface 212.

The illustrated premium finance manager 200 is merely an example of a suitable environment for the system of the invention and is not intended to suggest any limitation as to the scope of use or functionality of the invention. Neither should the premium finance manger 200 be interpreted as having any dependency or requirement relating to any one or combination of components illustrated.

The premium finance manger 200 in the present invention may operate in a networked environment using logical connections to communicate with networked components. Logical connections for networking may include a local area network (LAN) or a wide area network (WAN), but may also include other networks. When used in a LAN networking environment, the system may be connected to the LAN through the network interface 216 or adapter. When used in a WAN networking environment, the security system server 200 typically includes a modem or other means for establishing communications, such as the Internet. The modem, which may be internal or external, may be connected to the system bus 220 via the user input interface 218 or other appropriate mechanism.

Although only the premium finance manager 200 has been described in detail with respect to the appropriate computerized environment, it should be understood that the other components shown in FIG. 1, operate in a similar computerized environment.

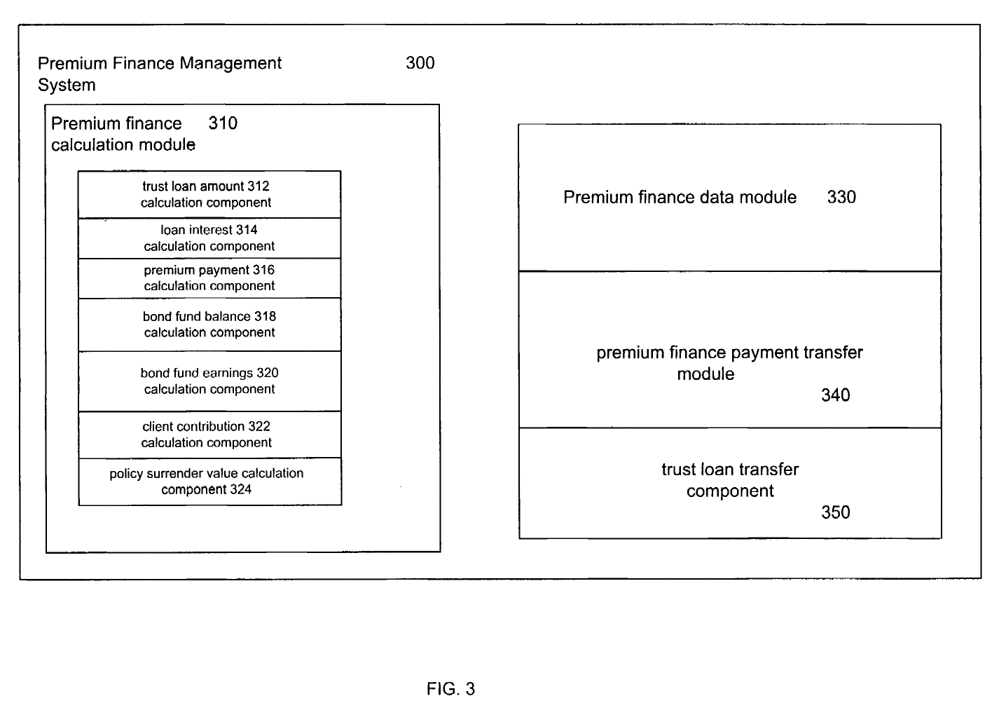

FIG. 3 is a block diagram illustrating the premium finance management system 300 in accordance with an embodiment of the invention. As stated above, the premium finance management system 300 may include a plurality of applications or modules. A premium finance calculation module 310 may determine and track dollar amounts required for the premium financing structure. A premium finance data module 330 may store relevant financial data. A premium finance payment transfer module 340 may facilitate payment of premiums and a trust loan transfer component 350 may facilitate establishment of the bond investment fund from the acquisition of the trust loan.

The premium finance calculation module 310 may include multiple calculation tools necessary for managing funds. A trust loan amount calculation component 312 may determine a necessary trust loan amount based on premiums due. A loan interest calculation component 314 may determine interest due on the trust loan. A premium payment calculation component 316 may determine the amount and frequency of premium payments required. A bond fund balance calculation component 318 may calculate and track the value of the bond investment fund. A bond fund earnings calculation component 320 may calculate the amount of interest earned by the bond investment fund. A client contribution calculation component 322 may determine a shortfall of the bond investment fund for covering costs such as a letter of credit cost and interest due on the loan from the trust. The pertinent cost data may be stored in the premium finance data module 330. These shortfalls may be covered by the policy holder or by other available sources. The premium finance calculation module 310 may also include a policy surrender value calculation component 324 for determining the cash value of the policy, which typically may be used to pay premiums after the bond investment fund is depleted. These calculation modules are merely exemplary and others may be included.

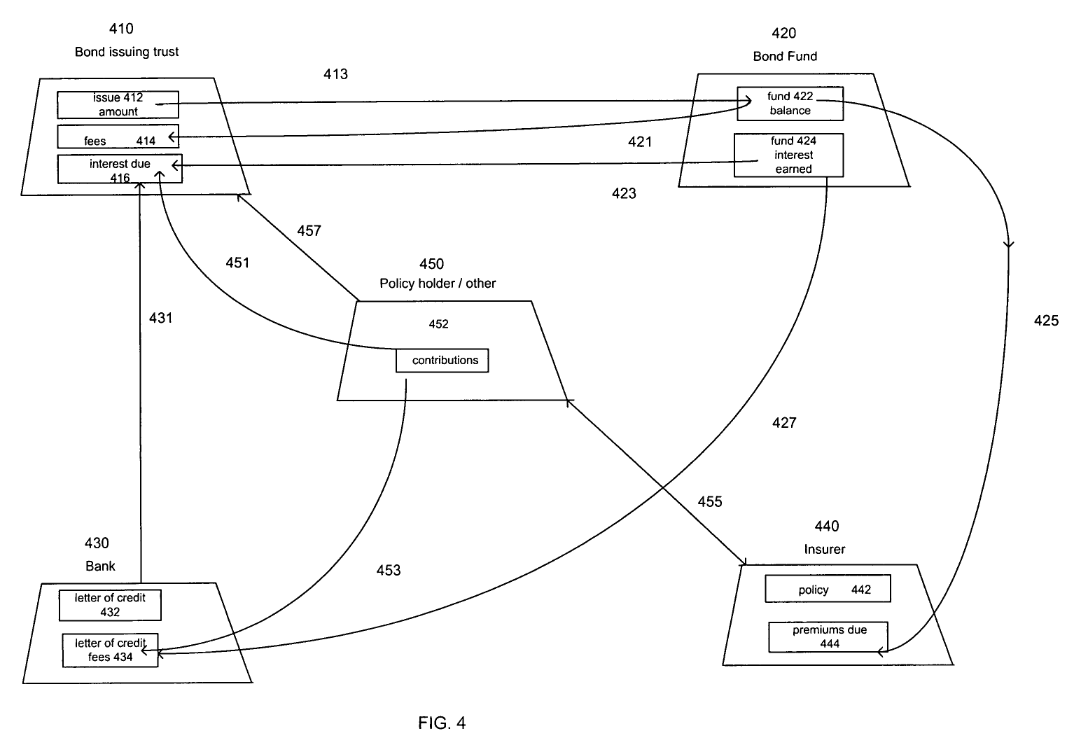

FIG. 4 shows a more detailed view of the transactions between participating entities. An insurer 440, upon request 455 of the policy holder 450, issues a policy 442 and premiums 444 become due. The policy holder 450 takes a loan in an issue amount 412 from a bond issuing trust or other entity 410. The taxable variable rate bonds in an issue amount 412 are transferred at 413 to an investment bond fund 420 having a fund balance 422. The investment bond fund 420 earns interest 424. The premiums due 444 are paid at 425 from the fund balance 422. Upon request 453 by the policy holder 350, a bank 430 issues at 431 a letter of credit 432 for the bond issuing trust 410.

In addition to the premiums due 444, the premium financing arrangement gives rise to additional costs. The bond issuing trust 410 charges fees 414 for issuing the taxable variable rate bonds. Additionally, the bond issuing trust 410 charges interest 416 on the loan. Furthermore, the bank 430 charges a letter of credit fee 434 for issuing a letter of credit. To cover these additional costs, the policy holder 450 may be required to make contributions 452 to the bank 430 and at 453 and to the trust 410 at 451. In addition or alternatively, the interest earned 424 by the bond fund 420 may be used to pay the interest due 416 at 423 and the letter of credit fees 434 at 427.

The premium finance manager 300 may be implemented and inserted in the displayed arrangement in order to arrange the above-described transactions. The premium finance manager 300 may also include components that allow it to operate as a proxy for one or more of the participating entities.

In an exemplary embodiment for funding premiums on a ten million dollar life insurance policy, a trust or other entity may issue taxable variable rate bonds in the amount of $4,610,000. At closing, $4,480,000 from this amount may be deposited in an investment bond fund to pay the annual insurance premiums of $682,000. These annual insurance premiums are typically paid over a seven year period or “seven-pay” as the IRS allows the insured to “front-load” the insurance policy. The life insurance products have a high cash value in proportion to the insurance premiums. For example, in this scenario, while the premium for year one is $682,000, the cash value of the policy is $431,000. A bank letter of credit is secured with this policy cash value and the bond proceeds in the investment fund.

If any shortfall exists in the cash value of the policy and the investment fund in relation to the amount of the letter of credit, the insured may cover the shortfall with additional collateral or personal guarantee. However, the client's contribution is minimized compared to that required in traditional financing structures. In a traditional structure, the client contribution would have been $178,000 each year for the seven-pay. A comparison is shown below in Table 1. The total client savings for the seven years is $931,000.

TABLE 1

| | Traditional | Current Client | |
|---|---|---|---|
| YEAR | contribution | contribution | Savings |
| One | 178,000 | 0 | 178,000 |
| Two | 178,000 | 11,000 | 167,000 |
| Three | 178,000 | 44,000 | 134,000 |
| Four | 178,000 | 55,000 | 123,000 |
| Five | 178,000 | 62,000 | 116,000 |
| Six | 178,000 | 68,000 | 110,000 |
| Seven | 178,000 | 75,000 | 103,000 |

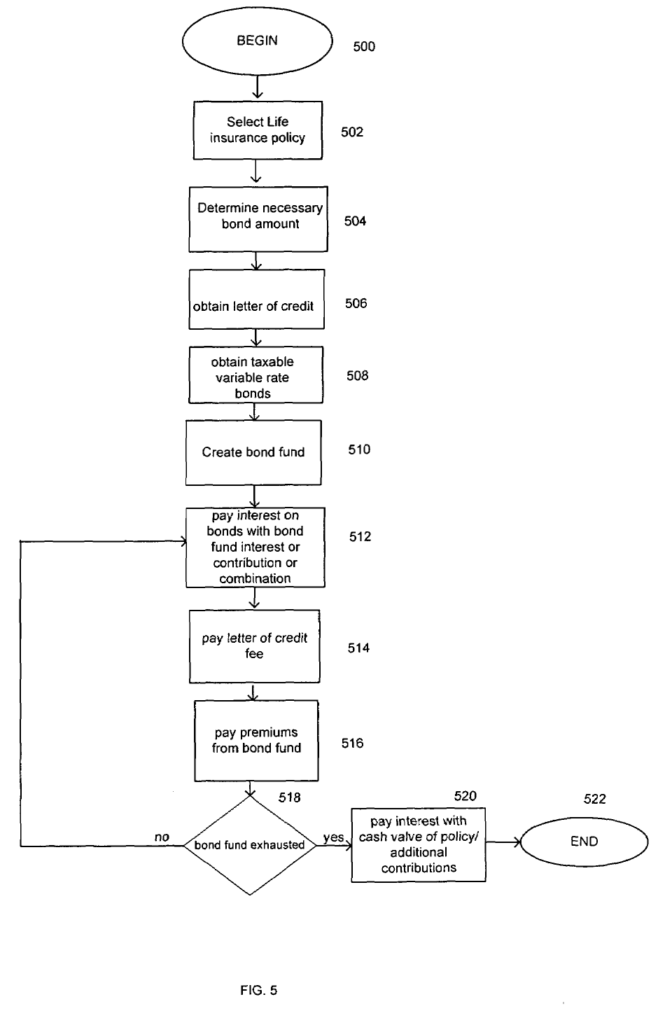

FIG. 5 is a flow chart illustrating a premium financing method in accordance with an embodiment of the invention. The method begins in step 500 and a life insurance policy is selected in step 502. In step 504, the premium financing manager may determine the necessary bond amount. In step 506, a letter of credit is obtained from the letter of credit issuing bank. In step 508, taxable variable rate bonds are issued by the trust. In step 510, the finance manager creates the bond investment find. In step 512, the interest on the bonds is paid with fund interest, policy holder contribution, or a combination of the two. In step 514, the letter of credit fee may be paid from the same sources. In step 516, the premiums due are paid from the bond fund. In step 518, if the bond fund is not exhausted, steps 512, 514, and 516 may be repeated. If the bond fund is exhausted, additional costs are paid with the cash value of the policy or with additional contributions in step 520. The process ends in step 522. The particular order of the steps described above may be varied and the described scenario is merely exemplary.

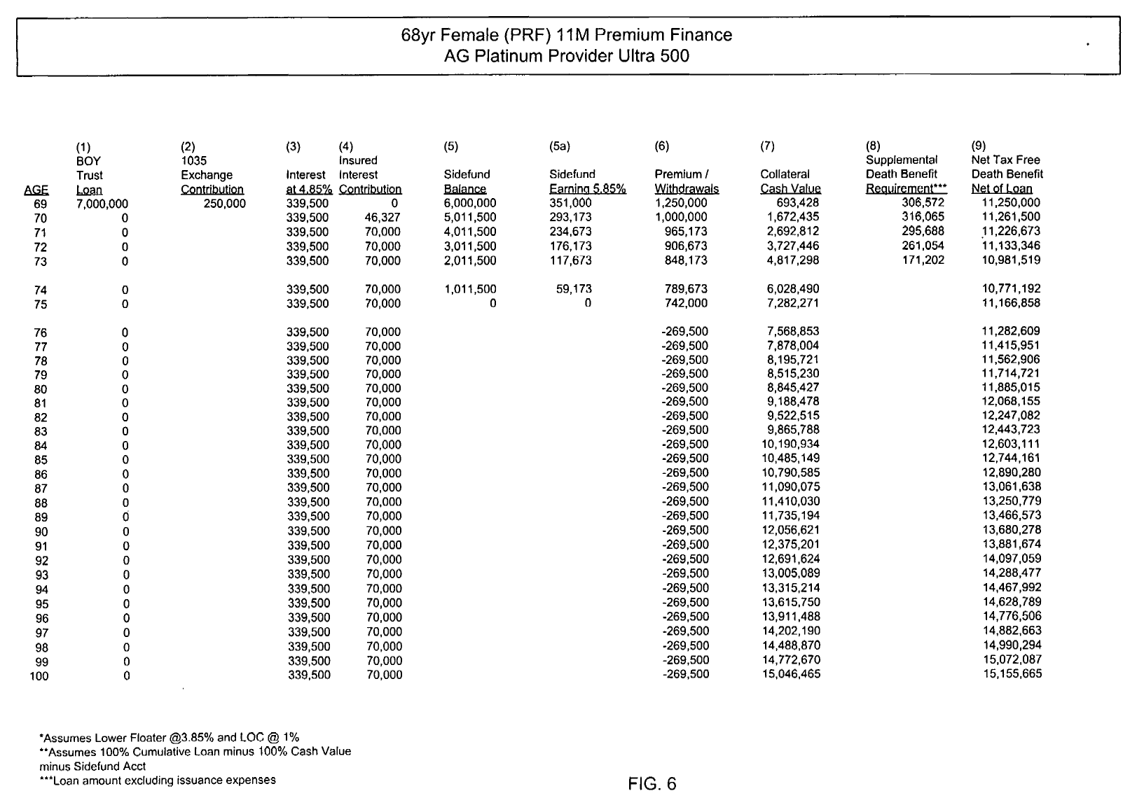

FIG. 6 is a spreadsheet illustrating an exemplary premium finance scenario. In column (1), the trust loan amount is shown as 7,000,000 dollars. Column (2) shows a 1035 exchange contribution to finding of the policy. Column (3) illustrates interest charged on the issued bonds at 4.85%. This assumes a taxable lower floater rate of 3.85% and a letter of credit fee of 1%. Column (4) illustrates yearly contributions from the insured. Column (5) illustrates the bond fund balance. Column (5a) illustrates the bond fund earnings at 5.85%. Column (6) illustrates the amount of withdrawals from the bond find for payment of premiums. The illustrated scenario assumes premium payments for the first seven years and subsequent withdrawals from the policy to help pay loan interest. Column (7) illustrates the collateral cash value of the policy and its yearly increases. Column (8) illustrates a supplemental collateral requirement, or cumulative loan minus cash value minus the bond fund account. Column (9) illustrates the net tax free death benefit.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A premium financing method for financing life insurance premiums for a life insurance policy issued by an insurer, the premium financing method comprising:
obtaining taxable variable rate bonds from a bond issuing entity for funding the life insurance premiums;
creating an interest earning bond fund with the taxable variable rate bonds;
causing payment of the life insurance premiums to the insurer from the bond fund; and
arranging for coverage of additional costs with bond fund interest.

2. The method of claim 1, wherein coverage of additional costs comprises coverage of interest due on the taxable variable rate bonds.

3. The method of claim 1, further comprising obtaining a letter of credit from a bank.

4. The method of claim 3, further comprising arranging for payment of a letter of credit fee from at least one of bond fund interest and policy holder contributions.

5. The method of claim 1, further comprising arranging for payment of fees due to the bond issuing entity from bond fund interest.

6. The method of claim 1, further comprising arranging for payment of the life insurance premiums from the interest earning bond fund for seven years.

7. The method of claim 6, further comprising arranging for payments after seven years from policy cash value.

8. A computer readable medium comprising computer executable instructions for performing the method of claim 1.

9. A premium financing management system for managing financing of premiums for a life insurance policy issued by an insurer, the premium financing management system comprising:
a loan amount calculation component for calculating a loan amount for issuance of taxable variable rate bonds from a bond issuing entity, the calculation based on life insurance premiums to be paid;
a loan transfer component for transferring the taxable variable rate bonds to an interest earning bond fund; and
a premium payment transfer component for transferring premiums from the bond fund to the insurer.

10. The system of claim 9, further comprising a bond fund earnings calculation component and a bond fund balance calculating component for calculating earnings and current balance of the interest earning bond fund.

11. The system of claim 9, further comprising a client contribution calculation component for determining a required client contribution for fee payment.

12. The system of claim 11, wherein fee payment comprises payment of a letter of credit fee and payment of interest due to the bond issuing entity.

13. A method for facilitating premium finance for a life insurance policy issued by an insurer and purchased by a policy holder, the method comprising:
causing formation of an agreement between the policy holder and a bond issuing entity, wherein the bond issuing entity issues variable taxable rate bonds for financing premiums of the purchased life insurance policy;
causing formation of an interest earning bond fund, wherein the issued variable taxable rate bonds are deposited in the interest earning bond fund; and
routing premium payments from the interest earning bond fund to the issuer of the life insurance policy.

14. The method of claim 13, further comprising arranging for coverage of additional costs with bond fund interest wherein coverage of additional costs comprises coverage of interest due on the taxable variable rate bonds.

15. The method of claim 13, further comprising obtaining a letter of credit from a bank.

16. The method of claim 15, further comprising arranging for payment of a letter of credit fee from at least one of bond fund interest and policy holder contributions.

17. The method of claim 13, further comprising arranging for payment of fees due to the bond issuing entity from bond fund interest.

18. The method of claim 13, further comprising arranging for payment of the life insurance premiums from the interest earning bond fund for seven years.

19. The method of claim 18, further comprising arranging for premium payments after seven years from policy cash value.
